(19) United States
(12) Patent Application Publication
(10) Pub. No.: US 2009/0308206 A1
(43) Pub. Date: Dec. 17, 2009

(54) CORKSCREW

(76) Inventor: Ruggero Ferrari, Parma (IT)

Correspondence Address: YOUNG & THOMPSON, 209 Madison Street, Suite 500, Alexandria, VA, 22314, US

(21) Appl. No.: 12/306,391

(22) PCT Filed: Jun. 23, 2006
(86) PCT No.: PCT/EP06/06056

§ 371 Date: Dec. 23, 2008

(51) Int. Cl. B67B 7/04

(52) U.S. Cl. 81/3.37; 81/3.29

(57) ABSTRACT

A corkscrew (1) with fulcrum moving and acting alternately in two different positions: the first one to screw the worm into the cork; the second one to extract it. The three operations (screwing, extracting and ejecting the cork) take place with a single reciprocating movement of two-lever (12).

The present invention refers to a corkscrew

Object of the present invention is providing a corkscrew according to the following claims.

The advantages reached by the corkscrew subject of the present invention are the following:
Reduction of the strength required
Reduction of the time required to carry out the operation
Cost reduction

More particularly, by just one simple reciprocating movement of the levers, the corkscrew subject of the present invention screws extracts and ejects the cork.

These objects and advantages are all reached by the corkscrew, subject of the present invention that is characterised by what is included in the below-listed claims.

This and other characteristics will be better pointed out by the following description of some embodiments that are shown, merely as a non-limiting example, in the enclosed tables of drawing in which:

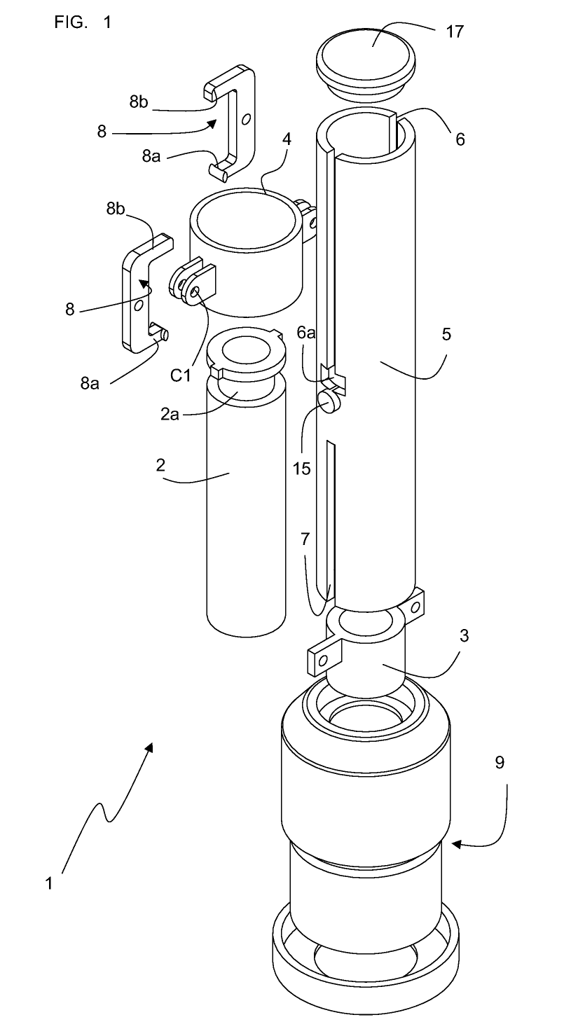

FIG. 1 shows An exploded view of the corkscrew subject of the present invention,

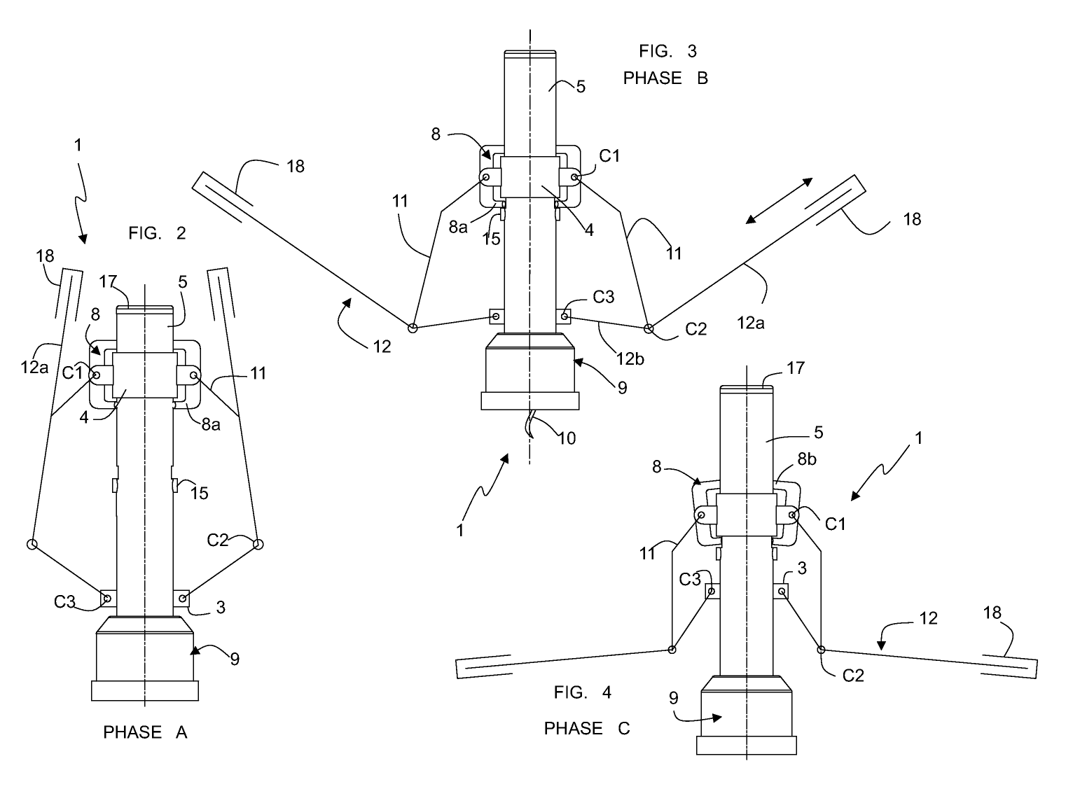

FIG. 2 shows The corkscrew in its starting arrangement where the worm is prepared and raised,

FIG. 3 shows The corkscrew in a second arrangement where the worm penetrates into the cap,

FIG. 4 shows The corkscrew in a third arrangement where the cap is extracted,

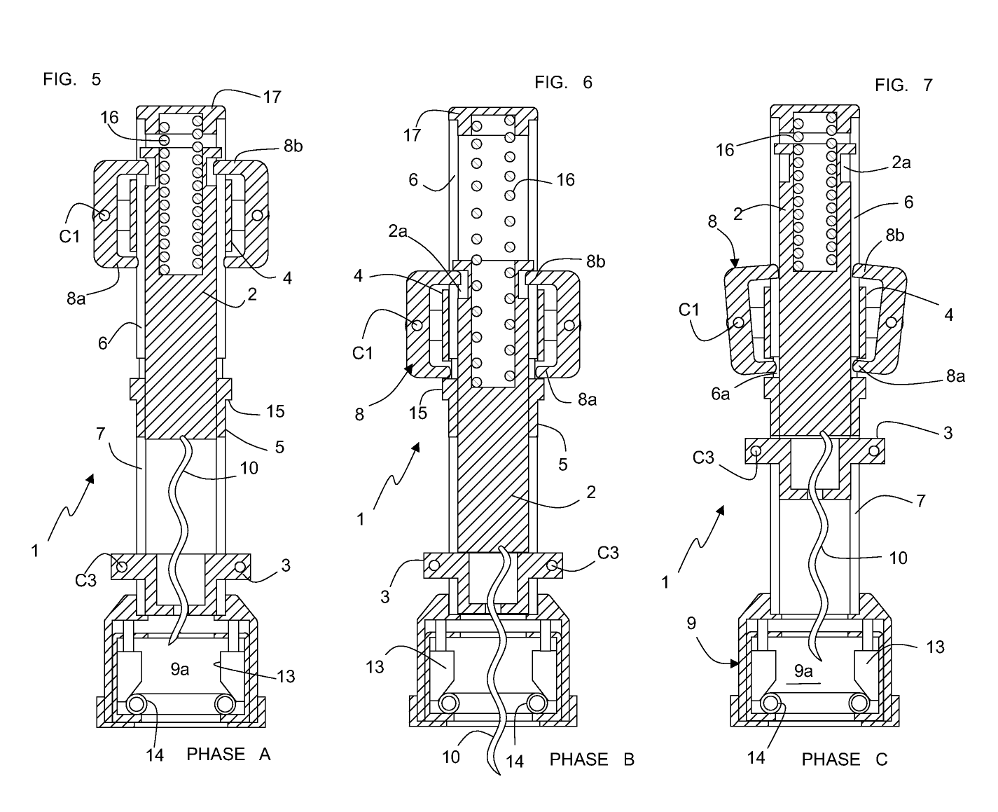

FIG. 5 shows A midsection of the corkscrew according to FIG. 2 arrangement,

FIG. 6 shows A midsection of the corkscrew according to FIG. 3 arrangement,

FIG. 7 shows A midsection of the corkscrew according to FIG. 4 arrangement.

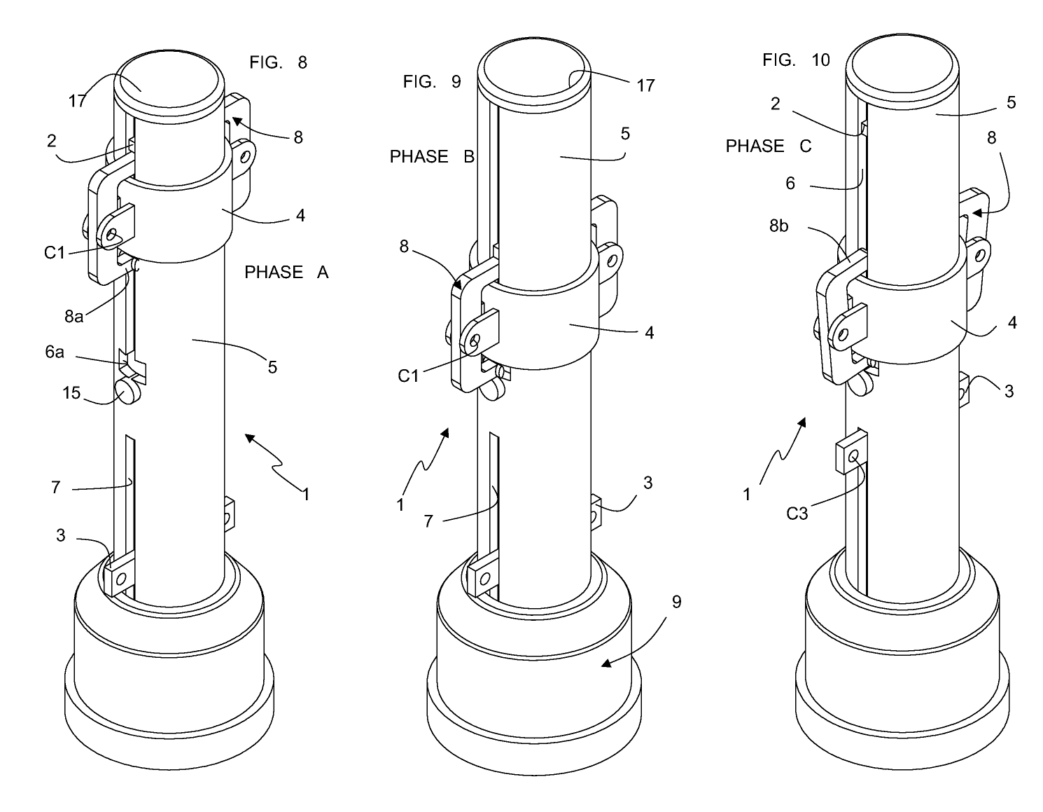

FIGS. 8, 9, 10 show a perspective view of the three above mentioned corkscrew arrangements shown in FIGS. 5, 6 and 7.

With reference to FIGS. 1 and 3, 1 designates a corkscrew different from the others for the following extraordinarily profitable characteristic: its fulcrum is mobile since it is present and acting alternately in two different positions: the first one to screw the worm into the cork, the second one to extract it effortlessly.

Moreover, the three operations (screwing, extracting and ejecting the cork) take place with a single reciprocating movement of two levers, as explained below.

The corkscrew 1 is essentially composed of a hollow tubular body 5 suitable to allow coupling with a corresponding barrel 2, a bush 3 and a neck 4; barrel 2 and bush 3 slide inside said tubular body 5, whereas neck 4 slides along its external skirt.

Barrel 2 and bush 3 are kept in proper position by grooves 6 and 7 obtained at the top and at the bottom of the tubular body 5, namely bush 3 is suitable to engage in lower grooves 7, whereas barrel 2 engages in the above ones designated by reference 6.

Grooves 6 end approximately in the middle of the tubular body 5 with an opening 6a into which it is possible to suitably position the tooth 8a of a C-shaped hook 8 hinged to neck 4 and free to move with respect to said hinge, in order to mesh with groove 2a of barrel 2 or with said opening 6a.

Coupling to groove 2a is performed through the other upper tooth 8b, opposite to the above mentioned tooth 8a.

More precisely, corkscrew 1 has two hooks 8 connected on opposite sides but on the same neck 4.

On hinges C1 of hooks 8 have also their fulcrum on one of their ends, rods 11 for operating the neck 4.

The opposite side of said rods 11 is coupled, by another hinge coupling C2, to one of the corkscrew 1 levers 12 for operating the members 2, 3 and 4, as explained below.

Coupling C2 set in the middle of lever 12 obtains two arms 12a and 12b: arm 12a is the veritable operating one, hold by the user when extracting the cap, whereas arm 12b is used as transmission for the movement of bush 3 to which it is connected through another hinge coupling C3.

Under bush 3, namely screwed to body 5, is fitted a device 9 for locking the bottle neck, of known type, and including inside a garter spring 14 that is forced by suitable blocks 13 set in circle above said spring 14 to lock the pad: in this way during the screwing phase, the corkscrew 1 is not lifted.

On the lower end of barrel 2 is located, free of rotating according to its own axis which is essentially parallel to that of the tubular body 5, the so-called worm 10 for extracting the cork, whereas the upper end of barrel 2 features a cavity housing a spring 16 that keeps it pressed downwards, according to the positions of the operating levers 12, as explained below.

The tubular body is closed on the top by a cover 17, after fastening on it the previously described members 2, 3 and 4 and spring 16; and on the lower side by the bottle neck locking device 9.

The end of each arm 12a can be equipped with extensible handles 18 that reduce the physical extraction effort.

Here below is described the operation of the corkscrew 1, detailed by FIGS. 2 to 10.

Operation occurs in three phases:
The first phase, designated with A, is the preparation of the corkscrew 1 by lifting and locking, if required, levers 12 on the corresponding rods 11. At the same time, the barrel 2 and the worm 10 are lifted by the neck 4 that sets at the upper side of the tubular body 5 carrying also the hooks 8 that during this phase remain inserted into the groove 2a by means of the upper teeth 8b. The spring 16 is compressed; whereas the bush 3 remains at the lower end of the tubular body 5, namely close to the locking device 9.
After fitting the bottle neck into the space 9a of the locking device 9 and tightening the pad by the garter spring 14 (not-shown arrangement) starts phase B that consists in worm 10 inserting into the cork due to barrel 2 descent caused by the lowering of the levers 12. The barrel stops its stroke when it arrives close to, or even against the bush 3, since now teeth 8a can enter the cavity 6a thus disengaging the corresponding teeth 8b from groove 2a of barrel 2.
Continuing to lower the levers 12 will obtain to lift and extract the cork since hooks 8 will disengage from groove 2a and will fit into cavity 6a thus stopping the lifting stroke of neck 4 to which they are hinged; as a consequence levers 12 will lift the barrel 2 through the action of the bush 3 which slides along grooves 7, as described previously. Rising of bush 3 will thus extract the cork by the worm 10 and will compress the spring 16.

Now it just remains to release the uncorked bottle.

As already previously mentioned, during the preparation phase in addition to lift levers 12 it will also be possible to lock them on rods 11 and specifically arms 12a.

The outlined solution can be obtained through an arrangement of lever arms and rods such as to insert arm 12a into a space created by the splitting of rods 11 arms: it is now possible to create a boss on one member and an indentation on the other one in order to obtain the required locking.

Locking will be manual.

According to a not-shown possible embodiment, spring 16 can be located in a position different than that shown and be inserted between bush 3 and the lower surface of the barrel, i.e. the end housing worm 10, or in both positions.

The tubular body 5 shall preferably have round section, but it could also have whatever section, and the fastening elements 2, 3, 4 shall have the same section as a consequence.

1. Corkscrew (1) characterised in that it comprises
a. a tubular body (5) along which can slide, being coupled, a corresponding barrel (2), a bush (3) and a neck (4); the barrel (2) and the bush (3) being internally sliding and driven by the corresponding grooves (6,7) obtained at the top and at the bottom of said tubular body (5), the neck (4) being sliding along its external skirt,
b. at least two hooks (8) with fulcrum on hinge couplings (C1) of opposite neck (4) sides; each hook (8) C-shaped and free to move with respect to said hinge (C1) in order to engage two different positions: the first one to lift and to screw the worm into the cork; the second one to extract it effortlessly,
c. at least two rods (11) and levers (12) hinged with each other by hinge couplings (C2), such as to define two arms (12a, 12b) of lever (12) and connected, to the other end, respectively with said neck (4) at hinge coupling (C1) and with said bush (3) by another hinge coupling (C3).

2. Corkscrew, according to claim 1, characterised in that said first position is defined by fitting the hook (8) tooth (8b) into a groove (2a) obtained on the upper side of barrel (2).

3. Corkscrew, according to claim 1, characterised in that said second position is defined by fitting the hook (8) tooth (8a) into an opening (6a) obtained at the bottom of groove (6).

4. Corkscrew, according to claim 1, characterised in that on the lower end of barrel (2) is located, free of rotating according to its own axis which is essentially parallel to that of the tubular body (5), the so-called worm (10) for extracting the cork.

5. Corkscrew, according to claim 1, characterised in that the upper end of barrel (2) features a cavity housing a spring (16) that keeps it pressed downwards, according to the positions of the operating levers (12).

6. Corkscrew, according to claim 1, characterised in that screwed on the lower end or secured anyhow to the tubular body (5), is fitted a device (9) for locking the bottle neck housing inside a garter spring (14) that is forced by suitable blocks (13) set in circle above said spring (14) to lock the pad: in this way during the screwing phase, the corkscrew (1) is not lifted.

7. Corkscrew, according to claim 1, characterised in that the arm (12a) can be inserted, in the arrangement of levers (12) lifted, into a space created by the splitting of rods (11) arms: bosses and indentations respectively created on the two members lock the corkscrew (1) in that particular position.

8. Corkscrew, according to claim 1, wherein on the lower end of barrel (2) is located, free of rotating according to its own axis which is essentially parallel to that of the tubular body (5), the so-called worm (10) for extracting the cork; and wherein the upper end of barrel (2) features a cavity housing a spring (16) that keeps it pressed downwards, according to the positions of the operating levers (12); and characterised in that the spring (16) is inserted between the bush (3) and the lower surface of the barrel (2), i.e. the end housing the worm (10), or in both positions.

9. Corkscrew, according to claim 1, characterised in that the ends of each arm (12a) can be equipped with extensible handles (18) that reduce the physical extraction effort.
